(19) United States
(12) Patent Application Publication
(10) Pub. No.: US 2023/0110431 A1
(43) Pub. Date: Apr. 13, 2023

(54) DEVICE FOR IMPROVING THE TRANSMISSION BEHAVIOR OF RADAR WAVES, EXTERNAL CLADDING COMPONENT OF A VEHICLE AND VEHICLE COMPRISING SUCH AN EXTERNAL CLADDING COMPONENT

(71) Applicant: Motherson Innovations Company Limited, London (GB)

(72) Inventor: Benjamin Sepp, Gengenbach (DE)

(73) Assignee: MOTHERSON INNOVATIONS COMPANY LIMITED, London (GB)

(21) Appl. No.: 17/962,794

(22) Filed: Oct. 10, 2022

(30) Foreign Application Priority Data
Oct. 11, 2021 (EP) 21 201 984.8

(51) Int. Cl. G01S 13/931

(52) U.S. Cl. CPC G01S 13/931

(57) ABSTRACT

A device for improving the transmission behavior of radar waves (λ) is disclosed, which includes a wall section where in a first location a first and a second surface are located at a first wall thickness distance (dw1) and in a second location the first surface and the second surface are located at a second wall thickness distance (dw2) and differing relative to each other by a first value (Δ1). An equilibration body mounted on the first surface of the wall section, such that in the first location a first body surface and a second surface are located at a first distance (de1) relative to each other and in the second location the first body surface and the second surface are located at a second distance (de2). The first distance (de1) and the second distance (de2) differ from each other by a second value (Δ2) such that second value (Δ2) is smaller than the first difference (Δ1). An external cladding component of a vehicle and vehicle including the device is also disclosed.

### CROSS-REFERENCES TO RELATED APPLICATIONS

This application claims the priority of European Patent Application Serial No. 21 201 984.8, filed Oct. 11, 2021, pursuant to 35 U.S.C. 119(a)-(d), the subject matter of which is incorporated herein by reference.

### BACKGROUND OF THE INVENTION

The present disclosure relates to a device for improving the transmission behavior of radar waves and relates to an external cladding component of a vehicle comprising such a device. Moreover, the present disclosure relates to a vehicle comprising such an external cladding component.

To enhance the operational safety, modern vehicles are equipped with a number of assistance systems assisting the vehicle driver. Many assistance systems are based on the monitoring of the surroundings of the vehicle and interact with respective sensors. Based on the situation identified in the surroundings of the vehicle, the assistance systems may take action. Such an action may be to generate a signal, e.g. in optical or acoustic form, to draw the driver's attention to a certain situation. Such a situation could be that objects are identified in the surroundings that may collide with the vehicle if no counteractions are taken. Another action may be that the assistance systems initiate a braking manoeuver and/or to intervene in the steering to conduct an evasive manoeuver. The monitoring of the surroundings of a vehicle is a key issue in autonomous driving.

To monitor the surroundings, the sensors may comprise a source for electromagnetic waves that are emitted to the surroundings. In case an object is present in the surroundings, the electromagnetic waves are reflected and detected by a respective receiver. The situation in the surroundings of the vehicle can thus be characterized. The degree a certain object reflects the electromagnetic waves amongst others depends on the material the object is made of. Other factors are the size of the object and the effective reflection surface. Consequently, vehicles are equipped with sensors using electromagnetic waves of different wavelength and frequency ranges. One important kind of electromagnetic waves are radar waves. The respective radar sensors comprise a radar source for generating and emitting radar waves and a receiver for receiving the reflected radar waves.

Due to design reasons, the sensors are often located behind the external cladding component to be invisible or almost invisible from the exterior. Therefore, the electromagnetic waves emitted by the respective sources have to traverse or penetrate the external cladding component of the vehicle to reach the exterior of the vehicle. In many cases, the external cladding components are made of plastics, in particular of thermoplastics, which dampen the electromagnetic waves to a certain degree. The more the waves are dampened, the smaller is the detection range by which the sensors can monitor the surroundings of the vehicle. The degree by which the electromagnetic waves are dampened depends on several factors, some of which are the wall thickness of the external cladding component and traveling distance. Other factors are the material the external cladding component is made of and the properties of the lacquer or coating applied on the external cladding component and, in particular, to the finished surface.

Ways to reduce the attenuation of electromagnetic waves are disclosed in DE 100 53 517 A1, DE 198 19 709 A1, DE 10 2018 211 786 A1, DE 102 59 246 A1, WO 2006/042725 A1 and WO 2007/045452 A2.

In almost all cases, the external cladding components made of plastics are manufactured by injection molding. The majority of the external cladding components are usually formed by a base body forming a wall section. The wall section comprises a first surface and a second surface. In the following, the second surface is the surface visible from outside. The first surface is located at a distance from each other which is often referred to as the wall thickness.

To ensure that the liquid plastic injected into the mold can reach areas located comparatively far away from the injection point of the base body, the wall thickness decreases with increasing distance from the injection point. As mentioned above, the attenuation of the radar waves upon penetrating the external cladding component depends on the wall thickness. The radar sensor emits the radar waves within an area that has a shape approximately equaling a cone. Due to the changing wall thickness. the attenuation of the radar waves within the cone is different which leads to a poor performance of a given radar sensor among others in respect of the detection range and the resolution accuracy.

It would therefore be desirable and advantageous to provide an improved device for improving the transmission behavior of radar waves and external cladding component of a vehicle to obviate prior art shortcomings.

### SUMMARY OF THE INVENTION

It is one task of one embodiment of the present disclosure to present a device for improving the transmission behavior of radar waves by which the above described drawbacks can be eliminated or at least reduced and the performance of the radar sensor be improved.

The task is solved by the features specified herein, according to one embodiment. A device for improving the transmission behavior of radar waves according to one embodiment of the present disclosure, includes:
a wall section having a first surface and a second surface, wherein
   in a first location, the first surface and the second surface are located at a first wall thickness distance relative to each other, and
   in a second location, the first surface and the second surface are located at a second wall thickness distance relative to each other,
   the first wall thickness distance and the second wall thickness distance differ from each other by a first difference, and
an equilibration body mounted on the first surface of the wall section, the equilibration body
   having a first body surface and a second body surface, and
   being mounted on the first surface of the wall section via the second body surface,
radar waves that are emitted by a radar sensor when fastened to a mounting section
   impinge on the first body surface,
   enter the equilibration body and subsequently the wall section and
   leave the wall section via the second surface,
in the first location, the first body surface and the second surface are located at a first traveling distance relative to each other,
in the second location, the first body surface and the second surface are located at a second traveling distance relative to each other,
the first traveling distance and the second traveling distance differ from each other by a second difference,
the equilibration body being designed and mounted to the wall section such that the second difference is smaller than the first difference.

Usually, there are no wall thickness distances between the first location and the second location that either exceed the first wall thickness distance or fall below the second wall thickness distance.

The radar waves emitted by the radar sensor impinge on the first body surface, penetrate the equilibration body and the wall section and enter the surrounding, e.g. of a vehicle, via the second surface. By means of the equilibration body, the second difference is reduced compared to the first difference. As a consequence, the traveling distance of the radar waves through the equilibration body and the wall section and thus the attenuation of the radar waves within the cone mentioned above, is optimized which leads to an improved performance of the radar sensor.

A further embodiment may be characterized in that the second difference is zero. In this case, the traveling distance of the radar waves penetrating through the equilibration body and the wall section is extensively optimized leading to a high performance of the radar sensor.

In an alternative embodiment, the first body surface is plane at least in sections. As mentioned, cladding components of vehicles are often pronouncedly curved also leading to variations in the attenuation of the radar waves. It has been found out that the transmission and reflection behavior of the radar waves is improved when the first body surface is plane.

According to another embodiment, the equilibration body is fastened to the wall section by gluing, welding or molding. These ways of fastening the equilibration body to the wall section can be carried out quickly and can be automated.

According to another embodiment, the wall section is made of a first plastic and the equilibration body is made of a second plastic, the first plastic and the second plastic being the same plastic or differing from each other. There is no noteworthy limit in the choice of the plastic the equilibration body is made of. The first plastic can be chosen in consideration of its attenuation effect on the radar waves. However, from a manufacturing point of view, it may be advantageous when the first plastic is the same as the second plastic which facilitates the fastening process by welding.

According to another embodiment, the first traveling distance and the second traveling distance are chosen such that the attenuation of the radar waves is at or near a minimum. It is worth mentioning that the degree of attenuation of the radar waves through a given body does not linearly increase with the traveling distance of the radar waves therethrough. The degree of attenuation approximately follows a sinusoid curve above the traveling distance. The shape of the equilibration body can thus be chosen such that the traveling distance is increased, such that the degree of attenuation is decreased. The performance of the radar sensor can thus be improved.

In another embodiment, the device comprises a mounting section for mounting a radar sensor, the mounting section either being fastened to the equilibration body or the wall section. A mounting section is needed for mounting a radar sensor. In this embodiment, the manufacturer of the device can also provide the same with the mounting section and possibly also fasten the radar sensor to the mounting section shortly after the device is finished and before the device is fastened to a vehicle. The manufacturing process is kept simple.

A further embodiment may be characterized in that the mounting section and the equilibration body or the mounting section and the wall section are made in one piece. The device, according to this embodiment, may be injection molded such that a large number of devices may be manufactured in a fast and cost-efficient way. It is not necessary to connect the mounting section and the equilibration body or the mounting section and the wall section to each other which on, one the hand, saves a manufacturing step and, on the other hand, ensures that the mounting section and the equilibration body are precisely positioned to each other.

According to another embodiment, the mounting section can comprise an absorption layer or can comprise absorptive material, wherein the absorption layer or the absorptive material absorbs the radar waves when the radar waves impinge on the mounting section. Depending on the opening angle and the location of the mounting section, it may not be avoidable that some radar waves impinge the mounting section. The surface of the mounting section may reflect the radar waves that may reach the radar detector without being reflected by an object in the surroundings of the vehicle. Moreover, some radar waves may be reflected on the first surface. In combination with the radar waves that imping the mounting section, multi-reflections may be generated which cause an interfering signal that may lead to misinterpretations. In this embodiment, radar waves impinging on the mounting section are absorbed, thereby avoiding interfering signals. The quality of the detection of objects in the surroundings of the vehicle is increased.

A further embodiment of the present disclosure is directed to an external cladding component of a vehicle, comprising
a base body, and
a device according to one of the preceding embodiments, the wall section forming a part of the base body.

The technical effects and advantages as discussed with regard to the present device equally apply to the external cladding component. Briefly, the transmission behavior of the radar waves impinging on the base body and penetrating the external cladding component is improved within the cone-shaped area leading to a better performance of the radar sensor mounted to the mounting section.

The device can be fastened to the base body of the cladding component, e.g. by welding or sticking. However, it is also possible to integrate the device into the cladding component such that a fastening step can be omitted.

A further embodiment may be characterized in that the wall section and the base body are formed by the same first plastic. Although the base body and the wall section may be made of different plastics, it may be beneficial to use the same first plastic for both the base body and the wall section. They could then be made in one piece. Moreover, in case they are made as separate pieces, they can be fastened to each other by welding.

As mentioned, the device can be made by injection molding. The same applies to the base body of the cladding component. However, it is not necessary that the base body is made of the same plastic as the mounting section and the wall section. The base body may have to fulfill requirements that are different from the requirements the mounting section and the wall section need to fulfill. The first plastic and the second plastic may be chosen such that each requirement can be met.

In another embodiment, the second surface can be part of the outer surface of the cladding component. In this embodiment, the device may be embodied as a bezel, bumper fascia, a grille or the like such that the second surface of the device is visible from outside. In particular when the cladding component is embodied as a bumper, the latter usually comprises a plurality of bezels or grilles. In this embodiment, the device also fulfills the task of a bezel, a grille or the like, thereby keeping the number of components low.

In accordance with a further embodiment, a radar sensor may be fastened to the mounting section. In this embodiment, objects in the surroundings of the vehicle can be detected and respective signals generated. These signals may be used for assisting the driver and/or autonomous driving.

A further embodiment is drawn to a vehicle, comprising an external cladding component according to one of the previous embodiments or a device according to one of the preceding embodiments. The technical effects and advantages as discussed with regard to the present external cladding component equally apply to the vehicle. Briefly, the transmission behavior of the radar waves impinging on the base body and penetrating the external cladding component is optimized within the cone-shaped area leading to a better performance of the radar sensor mounted to the mounting section.

### BRIEF DESCRIPTION OF THE DRAWINGS

Other features and advantages of the present invention will be more readily apparent upon reading the following description of currently preferred exemplified embodiments of the invention with reference to the accompanying drawing, in which:

FIG. 1 is a principle sectional view of a wall section of an external cladding component of a vehicle according to the prior art,

FIG. 2 is a principle sectional view of a wall section of a first embodiment of an external cladding component of a vehicle comprising an equilibration body,

FIG. 3 shows the first embodiment of the external cladding component shown in FIG. 2 with radar sensors emitting radar waves that penetrate the equilibration body and the wall section,

FIG. 4 shows a second embodiment of an external cladding component in which the mounting section is connected to the equilibration body,

FIG. 5 shows a third embodiment of an external cladding component in which, like in the second embodiment, the mounting section is connected to the equilibration body,

FIG. 6 shows an external cladding component which comprises at least one device, according to one of the embodiments, shown in FIGS. 2 to 5, and

FIG. 7 shows a principle top view of a vehicle comprising a plurality of external cladding components of the present disclosure.

### DETAILED DESCRIPTION OF PREFERRED EMBODIMENTS

Throughout all the Figures, same or corresponding elements are generally indicated by same reference numerals.

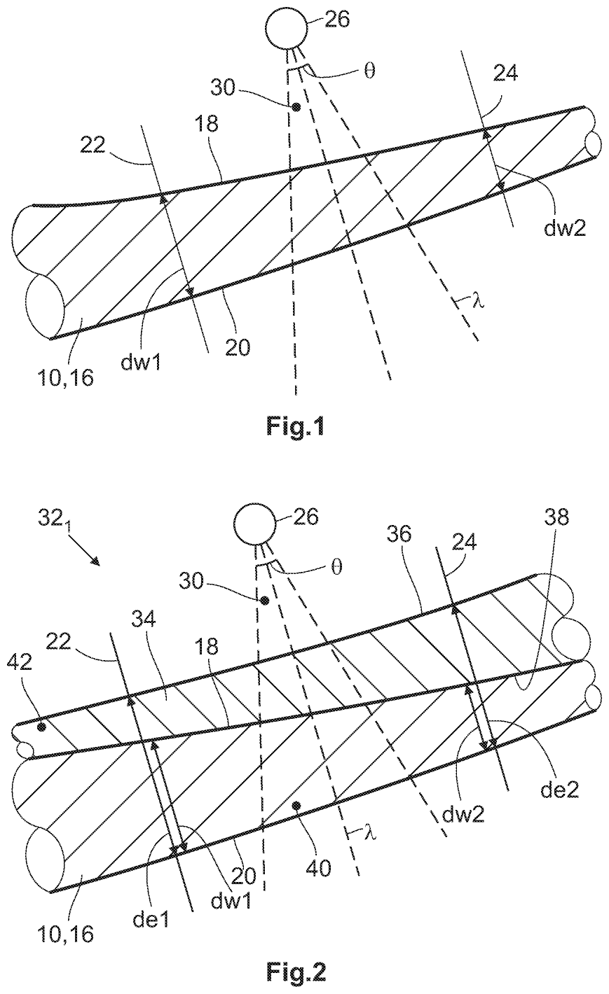

Turning now to the drawing, and in particular to FIG. 1, there is shown a wall section 10, in particular, of an external cladding component 12 of a vehicle 14 according to the prior art by means of a principle sketch. The wall section 10 may be part of a base body 16 of the external cladding component 12 (see FIG. 6). The wall section 10 comprises a first surface 18 and a second surface 20. While the first surface 18 faces the interior of the vehicle 14, the second surface 20 is directed towards the surroundings of the vehicle 14.

In a first location 22, the first surface 18 and the second surface 20 are located at a first wall thickness distance dw1 relative to each other. In a second location 24, the first surface 18 and the second surface 20 are located at a second wall thickness distance dw2 relative to each other. In other words, the wall section 10 has a first wall thickness at the first location 22 and a second wall thickness at a second location 24. The first wall thickness distance dw1 and the second wall thickness distance dw2 differ from each other by a first difference Δ1, which means that the first wall thickness and the second wall thickness are not equal. As can be seen from FIG. 1, the first wall thickness distance dw1 is bigger than the second wall thickness distance dw2. From the left to the right of FIG. 1, the wall thickness of the wall section 10 is continuously decreasing. Between the first location 22 and the second location 24, there are no wall thickness distances that either exceed the first wall thickness distance dw1 or fall below the second wall thickness distance dw2.

The first difference Δ1 may also be expressed by following equation:

Δ1=|dw1−dw2|

A radar sensor 26 creates radar waves λ that are emitted within a cone-shaped area 30 with a given opening angle θ. The radar waves λ emitted by a radar sensor 26 first impinge on the first surface 18, penetrate the wall section 10, and then enter the surroundings via the second surface 20. The radar sensors 26 is mounted on a mounting section 28 which is not shown in FIG. 1 (cf. FIG. 4). The mounting section 28 may be formed by the chassis of the vehicle 14 (not shown).

When the radar waves λ penetrate the wall section 10, the radar waves are attenuated by the material of the wall section 10. What is more is that the external cladding components 12 of vehicles 14 are usually curved, which is also the case in the wall section 10 shown in FIG. 1 although the respective curvature is not particularly pronounced. Due to the curvature, each of the radar waves λ hit the first surface 18 by a different angle of incidence. Both the changing wall thickness and the curvature negatively affect the transmission behavior of the radar waves λ, traversing external cladding component 12 leading to a poor performance of the radar sensor 26.

FIG. 2 shows a first embodiment of the inventive device 32₁ for improving the transmission behavior of radar waves λ that are emitted by the radar sensors 26. The wall section 10 of the device 32₁ is identical to the one shown in FIG. 1. An equilibration body 34 is fastened to the wall section 10. The equilibration body 34 comprises a first body surface 36 and a second body surface 38. The first body surface 36 is facing the radar sensors 26 while the second body surface 38 is in contact with the first surface 18 of the wall section 10. The equilibration body 34 may be fastened to the wall section 10, e.g. by gluing, welding or molding. However, other ways of fastening are conceivable.

In the first location 22, the first body surface 36 and the second surface 20 are located at a first traveling distance de1 relative to each other. In the second location 24, the first body surface 36 and the second surface 20 are located at a second traveling distance de2 relative to each other. The first traveling distance de1 and the second traveling distance de2 may also be regarded as the sum of the respective wall thicknesses of the wall section 10 and the equilibration body 34. The first traveling distance de1 and the second traveling distance de2 differ from each other by a second difference Δ2.

The second difference Δ2 may also be expressed by the following equation:

Δ2=|de1−de2|

The equilibration body 34 is designed such that the second difference Δ2 is smaller than the first difference Δ1. The radar waves λ emitted from the radar sensors 26 first impinge on the first body surface 36, penetrate the equilibration body 34, and subsequently the wall section 10 before they enter the surroundings in particular of the vehicle 14 via the second surface 20. Due to the fact that the second difference Δ2 is smaller than the first difference Δ1, the traveling distance of the radar waves λ through the equilibration body 34 and the wall section 10 differs to a significantly minor degree compared to the traveling distance of the radar waves λ only penetrating the wall section 10 as shown in FIG. 1. By means of the equilibration body 34, the transmission behavior of the radar waves λ and thus the performance of the radar sensors 26 is improved.

As mentioned earlier, the degree of attenuation of the radar waves λ approximately follows a sinusoid curve as a function of the traveling distance, in this case in particular the first traveling distance de1 and the second traveling distance de2. The equilibration body 34 can be designed not only to minimize the second difference Δ2 but also to increase the first traveling distance de1 and the second traveling distance de2 such that the attenuation of the radar waves λ is at or close to a minimum of the sinusoid curve. As the slope of a sinusoid curve in the area of the minimum (or maximum) is small, differences in the traveling distance up to a certain degree only have a minor effect on the attenuation of the radar waves λ. Variations of the first wall thickness dw1 and the second wall thickness dw2 as well as in the size of the equilibration body 34, which may be caused by manufacturing inaccuracies, may in this case be acceptable.

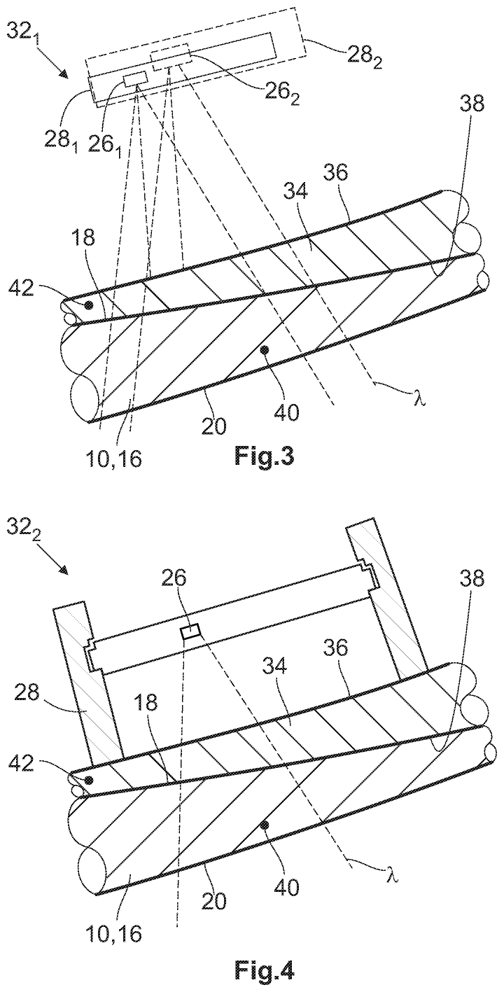

In FIG. 3, the device 32₁ is shown with a first radar sensor 26₁ and a second radar sensor 26₂, mounted on a first mounting section 28₁ and a second mounting section 28₂ respectively. The first radar sensor 26₁ and the first mounting section 28₁ as well as the second radar sensors 26₂ are shown in a very simplified way. The first radar sensors 26₁ and the first mounting section 28₁ are illustrated by solid lines, whereas the second radar sensors 26₂ and the second mounting section 28₂ are illustrated by dashed lines. Which one of the radar sensors 26 is used, may depend on the configuration of the vehicle 14. While the first radar sensors 26₁ may be used in a low cost configuration of the vehicle 14, the second radar sensor 26₂ may be used in a configuration suitable for autonomous driving.

The first radar sensor 26₁ and the second radar sensor 26₂ differ in size. The first mounting section 28₁ and the second mounting section 28₂ not only differ in size but also in their position relative to the device 32₁. As a consequence, the position of the area via which the first radar sensor 26₁ and the second radar sensor 26₂ emit the radar waves λ, differs relative to the device 32₁. Regardless of these differences, the device 32₁ generates an improved transmission behavior as long as the radar waves λ emitted by the first radar sensors 26₁ and the second radar sensors 26₂ impinge the equilibration body 34. The device 32₁ is thus fairly insensitive towards the mentioned differences and thus versatilely applicable.

This insensitivity is not only beneficial in the described case of two radar sensors 26₁, 26₂ but also in case of one radar sensor 26 only. It is not necessary to fasten the radar sensor 26 to the mounting section 28 with high precision, which facilitates and accelerates the fastening. Moreover, the position of the radar sensor 26 relative to the device 32₁ may change in operation of the vehicle. The change in position does not have a significant influence on the transmission behavior and thus the performance of the radar sensor 26.

FIG. 4 shows a second embodiment of the inventive device 32₂. The mounting section 28, to which the radar sensors 26 is mounted, is fastened to the equilibration body 34. The wall section 10 and the equilibration body 34 may have the same constitution as in the first embodiment of the device 32₁. The wall section 10 is made of a first plastic 40, and the equilibration body 34 is made of a second plastic 42. The first plastic 40 may differ from the second plastic 42. However, it may be advantageous if the first plastic 40 and the second plastic 42 are the same, in particular, if the equilibration body 34 is fastened to the wall section 10 by welding.

The mounting section 28 may be made of the same first plastic 40 as the equilibration body 34, which also facilitates the fastening of the mounting section 28 to the equilibration body 34, as mentioned above. However, it is also possible to fasten the mounting section 28 to the wall section 10. In this case, it may be beneficial to manufacture the mounting section 28 of the same second plastic 42 as the wall section 10. However, it is also possible to use three different plastics for the mounting section 28, the equilibration body 34, and the wall section 10.

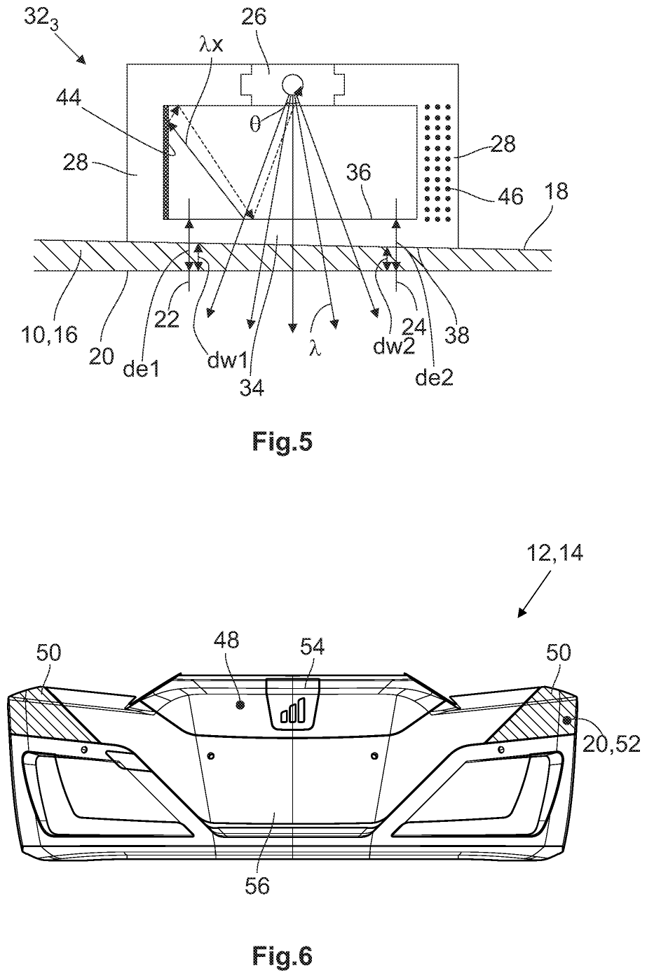

FIG. 5 shows a third embodiment of the inventive device 32₃. In this case the mounting section 28 and the equilibration body 34 are made in one piece. Moreover, the first surface 18 is plane and the second difference Δ2 is zero.

It can be seen from FIG. 5 that at least a part of the radar waves λ, which impinge on the first body surface 36, are reflected. The reflected radar waves λ are denominated with λx. The reflected radar waves λx impinge on the mounting section 28, from the mounting section 28 back to the first body surface 36, and from the first surface 18 to the radar sensors 26. The reflected radar waves λx may cause interfering signals in the radar sensors 26. To avoid such interfering signals, the mounting section 28 comprises an absorption layer 44 on which the radar waves λx impinge (see left hand side of the mounting section 28 of FIG. 5). Radar waves λx impinging on the absorption layer 44 are absorbed. The radar waves λx that are illustrated by the dashed lines are cancelled, and therefore cannot create interfering signals.

It is worth mentioning that in FIG. 5, the radar waves λx are only shown to explain the creation of interfering signals. In operation of the device 32₃, a plurality of reflected radar waves λx is expected.

Instead of an absorption layer 44, it is also possible to use an absorption material 46 that is added to the plastic the mounting section 28 is made of (see right hand side of the mounting section 28 of FIG. 5). Radar waves λx impinging on the mounting section 28 and comprising the absorption material 46 are not reflected to avoid interfering signals (not shown). The result is the same as in case an absorption layer 44 is used.

FIG. 6 shows an external cladding component 12 of a vehicle 14, in this case a front bumper 48. The front bumper 48 comprises two bezels 50 that are indicated by hatched areas. Each bezel 50 may be formed by a device 32₁, 32₂ according to the first or second embodiment (not shown in FIG. 6). In this case the second surface 20 of the device 32₁, 32₂ forms a part of an outer surface 52 of the cladding component 12.

A brand logo 54 of a given vehicle manufacturer is located in the upper center of the front bumper 48. The brand logo 54 may be formed by the device 32₁-32₃ according to one of the embodiments described above. The same may apply to a grille 56 that is integrated into the front bumper 48.

A number of devices 32₃ e.g. according to the third embodiment may be fastened to the front bumper 48 at any desired location.

It should be noted that it is not necessary that the front bumper 48 comprises a bezel 50. The devices 32₁ to 32₃ may also be mounted on a coated bumper fascia.

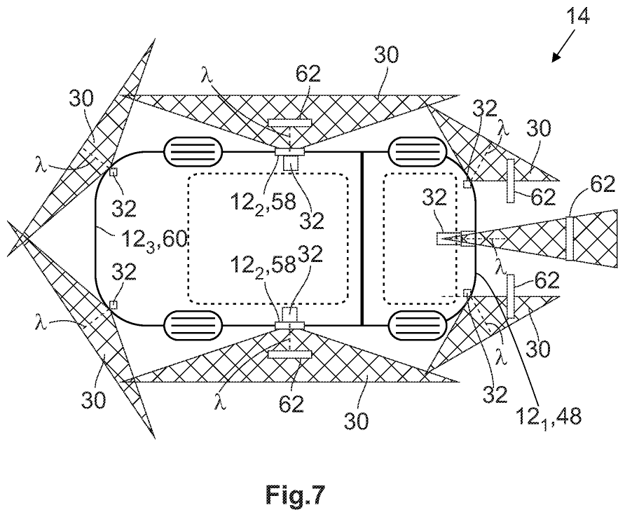

FIG. 7 shows a top view of a vehicle 14 being equipped with a plurality of external cladding components 12 to which one or more of the devices 32, according to one of the embodiments previously described, may be fastened. A first external cladding component 12₁ is embodied as a front bumper 48 such as shown in FIG. 6. Moreover, two second external cladding components 12₂ are embodied as B-pillar 58 claddings. A third external cladding component 12₃ is embodied as a rear bumper 60. The radar sensors 26 of the devices 32 may observe an object 62 in the surroundings of the vehicle 14 in case it is located within the cone-shaped area 30.

While the invention has been illustrated and described as embodied in a device for improving the transmission behavior of radar waves, external cladding component of a vehicle and vehicle comprising such an external cladding component, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A device for improving the transmission behavior of radar waves (λ), comprising
a wall section having a first surface and a second surface, said first and second surfaces, at a first location, are located at a first wall thickness distance (dw1) relative to each other, and
at a second location, the first and second surfaces are located at a second wall thickness distance (dw2) relative to each other; said first wall thickness distance (dw1) and said second wall thickness distance (dw2) differ from each other by a first value (Δ1),
an equilibration body mounted on the first surface of the wall section, said equilibration body having a first body surface and a second body surface, and mounted on the first surface of the wall section via the second body surface,
a radar sensor fastened to a mounting section emitting radar waves (λ) impinge on the first body surface by entering the equilibration body and subsequently the wall section, leaving the wall section via the second surface,
at the first location, the first body surface and the second surface are located at a first traveling distance (de1) relative to each other,
at the second location, the first body surface and the second surface are located at a second traveling distance (de2) relative to each other,
the first traveling distance (de1) and the second traveling distance (de2) differ from each other by a second value (Δ2),
the equilibration body being designed and mounted to the wall section such that the second difference (Δ2) is smaller than the first difference (Δ1).

2. The device according to claim 1, wherein the second value (Δ2) is zero.

3. The device according to claim 1, wherein the first body surface is plane, at least in sections.

4. The device according to claim 1, wherein the equilibration body is mounted to the wall section by gluing, welding or molding.

5. The device according to claim 1, wherein the wall section is made of a first plastic and the equilibration body is made of a second plastic, the first and second plastic either being the same or different.

6. The device according to claim 1, wherein the first traveling distance (de1) and the second traveling distance (de2) are chosen such that an attenuation of the radar waves (λ) is at or near a minimum.

7. The device according to claim 1, wherein the device comprises a mounting section for mounting a radar sensor, said mounting section either being fastened to the equilibration body or the wall section.

8. The device according to claim 7, wherein the mounting section and the equilibration body or the mounting section and the wall section are made in one piece.

9. The device according to claim 7, wherein the mounting section comprises an absorption layer or absorptive material wherein the absorption layer or the absorptive material absorb the radar waves (λ) when the radar waves (λ) impinge on the mounting section.

10. An external cladding component of a vehicle, comprising a base body, and a device according to claim 1, and the wall section forming a part of the base body.

11. The external cladding component according to claim 10, wherein the wall section and the base body are formed of the same plastic.

12. The external cladding component according to claim 10, wherein the second surface is part of an outer surface of the cladding component.

13. The external cladding component according to claim 10, wherein a radar sensor is fastened to the mounting section.

14. A vehicle comprising an external cladding component according to claim 10.

15. A vehicle comprising the device of claim 1.
